(19) United States
(12) Patent Application Publication
(10) Pub. No.: US 2005/0185104 A1
(43) Pub. Date: Aug. 25, 2005

(54) Optically active glazing

(75) Inventors: Claude Weisbuch, Paris (FR); Weijia Wen, Hong Kong (HK); Ping Sheng, Hong Kong (HK); Che Ting Chan, Hong Kong (HK); Weikun Ge, Hong Kong (HK)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Genewave

(21) Appl. No.: 11/041,579

(22) Filed: Jan. 24, 2005

Related U.S. Application Data
(63) Continuation of application No. PCT/FR03/02269, filed on Jul. 17, 2003.

(30) Foreign Application Priority Data
Jul. 25, 2002 (FR) 02 09460

(51) Int. Cl. G02F 1/15

(52) U.S. Cl. 349/16; 359/265

(57) ABSTRACT

Optically active glazing comprising two parallel plates of glass or the like that define between them a closed volume containing dielectric particles in suspension in a fluid, and electrodes formed on the plates and connected to an electrical power supply for moving and organizing the particles by means of dielectrophoretic forces and of interactions between particles.

### CROSS-REFERENCE TO RELATED APPLICATIONS

This application is a continuation of PCT/FR03/02269, filed Jul. 17, 2003, claiming priority from French Application No. 02 09460, filed Jul. 25, 2002 which is hereby incorporated herein in its entirety by reference.

### BACKGROUND OF THE INVENTION

The present invention relates to optically active glazing, in which characteristics of transmission, diffusion, reflection, and/or color can be varied in controlled manner.

Glazing of this type can be used in particular in the motor vehicle industry and in building, and has other applications that are very diverse and numerous.

Glazing has already been proposed that uses direct electrical effects such as electrochromic effects, but it has not enabled the looked-for results to be obtained. Other known systems are based on electro-optical effects of liquid crystals and are complex and expensive.

Display systems are also known based on electrophoretic effects in which charged particles are moved by controlling electric fields, as described for example in the articles by John Rogers et al., Proc. Nat. Acad. Sc. 48, 4835-4840 (2001), and by Albert, Comiskey et al., Nature 394, 253-255 (1998), and in U.S. Pat. Nos. 6,120,588 and 5,961,804. Those prior systems nevertheless present certain drawbacks, such as a lack of long-term stability in terms of particle charge.

### OBJECTS AND SUMMARY OF THE INVENTION

A particular object of the invention is to provide active glazing that does not present those drawbacks and that is simple, inexpensive, and very reliable over long periods of time.

To this end, the invention provides optically active glazing having optical characteristics of transmission, diffusion, reflection, and/or color that can be varied under control, the glazing comprising two plates of material such as glass or the like, for example, that are parallel and that define between them a closed volume, a fluid contained in said volume between the plates, a suspension of dielectric particles in the fluid, and control means for applying electric field gradients to said particles, enabling the particles to be moved and organized in directions that are parallel to the plates or perpendicular to the plates, under the action of interactions and dielectrophoretic forces.

The invention is thus based on controlled displacement of dielectric particles in suspension in a fluid. These non-charged particles are moved by an electric field gradient which acts on the electric dipoles of the particles (dielectrophoretic effect) and they are grouped together or agglomerated by interactions between particles leading to electro-rheological properties. The use of particles that are not electrically charged makes it possible to avoid problems of charge stability that are inherent to electrophoretic systems. Particle clumping enables the particles to be stored in selected zones between the plates in order to obtain overall optical effects, e.g. high contrast transmission or color effects. By modifying the electric field gradient applied to the particles, it is possible to separate the particles and reorganize them in other zones between the plates, in order to modify the overall optical effect and obtain in alternation a display and deletion of the display.

In addition, the variations in the dielectrophoretic forces or in the interactions as a function of particle size, dielectric properties, electric field frequency, and fluid entrainment effects make it possible to perform specific particle separation operations and to obtain multiple colors and contrast effects when using particles having different dielectric properties.

In addition, long particle retention times after the electrical power supply has been switched off make it possible to envisage operation that consumes very little electricity.

According to another characteristic of the invention, the means for applying electric field gradients comprise electrodes placed on said plates in said volume, and means connecting said electrodes to an electrical power supply.

The electrodes made by disposed in any desired configuration for obtaining looked-for optical effects. They may be formed on the plates by various means, for example by deposition and etching, by ink jet, by ink pad, etc. The electrodes may be opaque or semitransparent depending on the looked-for effects.

In a preferred embodiment of the invention, each plate carries at least two groups of electrodes.

The particles in suspension in the fluid may be of a very wide variety of types and can be made out of any dielectric material as a function of the looked-for optical effects and the required dielectric properties. Typically they have dimensions lying in the range 10 nanometers (nm) to 50 micrometers (μm) and can be of simple structure or of composite structure based on materials that are inorganic or organic, polymers, dyes, metals, etc.

The fluid used is preferably a liquid that is dielectric or a poor conductor of electricity, for example water or silicone oil, having dielectric properties and viscosity that are selected as a function of the looked-for effect.

The electrical power supply may be a direct current (DC) supply or an alternating current (AC) supply operating at a steady or a varying frequency.

According to yet another characteristic of the invention, the volume between the plates is partitioned into a plurality of small volumes that are separated from one another in substantially leaktight manner so as to avoid long-distance settling effects which would prevent short-distance movements under the effect of interactions and dielectrophoretic forces. These small volumes typically have dimensions lying in the range a few μm to 1 centimeter (cm). The partitions are made of any dielectric material, for example of glass or of polymer, and they are formed by any appropriate means, for example by stamping or other means.

The plates of the glazing are optionally identical and made of any suitable material, in particular of glass or of plastics material. One of the plates may be transparent and the other opaque, e.g. made of metal, when operating in reflection.

In general, the invention is applicable to active glazing and also to passive displays (non-emitting displays).

### BRIEF DESCRIPTION OF THE DRAWINGS

The invention will be better understood and other characteristics, details, and advantages thereof will appear more clearly on reading the following description given by way of example with reference to the accompanying drawing, in which:

FIG. 1 is a fragmentary diagrammatic view on a large scale and in cross-section showing glazing of the invention;

FIG. 2 is a plan view of an individual glazing cell; and

FIGS. 3, 4, and 5 are diagrammatic fragmentary views showing modes of operation for glazing of the invention.

### MORE DETAILED DESCRIPTION

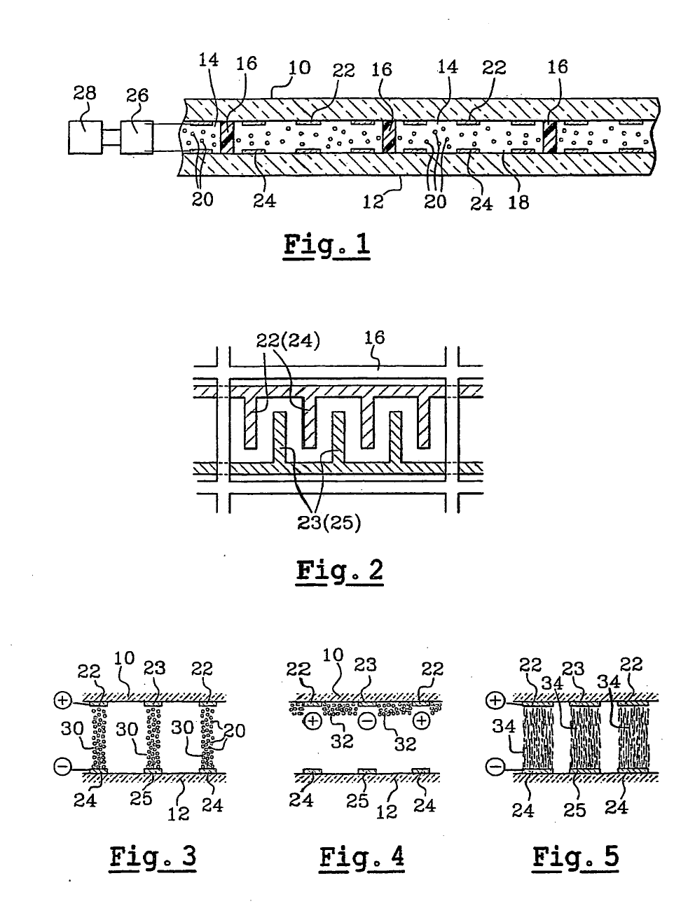

The glazing of FIG. 1 comprises two plates 10 and 12 of a transparent dielectric material such as glass or a plastic material, which plates are parallel and spaced apart by a small distance, e.g. lying in the range 0.01 millimeters (mm) to 1 mm, approximately, these two plates being identical to or different from each other.

The internal volume defined between the plates is subdivided into a plurality of small independent volumes or individual cells 14 that are separated in substantially leaktight manner by partitions 16 of dielectric material, e.g. of plastics material.

The individual cells 14 are filled with a fluid, preferably a liquid 18 that is dielectric or a poor conductor of electricity, which liquid contains a suspension of identical or differing particles 20 of dielectric material, said particles having a size lying in the range 0.01 μm to 50 μm, approximately.

The facing faces of the plates 10 and 12 carry electrodes 22, 24, e.g. of the same kind and disposed facing each other as shown in FIG. 1, but which could be of different kinds or disposed in offset manner in certain zones of the glazing or in certain embodiments. The electrodes are made of a suitable electrically conductive material and are of dimensions (thickness, width) that typically lie in the range 1 μm to a few mm, approximately. They are of any desired configuration (wires, tapes, combs, etc.). They are formed on the plates 10, 12 by any suitable means (deposition and etching, ink jet, ink pad, etc.).

The electrodes are connected to electrical power supply means 26 associated with control means 28. The electrical power supply means 26 may be DC or AC of variable frequency. Typically, the power supply voltages lie in the range 0.5 volts (V) to 500 V, and the frequency lies in the range 0 to 1 megahertz (MHz).

When the electrodes 22 and 24 are DC powered, all of the particles 20 move in the same direction, ignoring convection movements of the fluid, at speeds that differ depending on the nature and the size of each particle, and with different thresholds (the magnitude of the electric field beyond which particles begin to move). If some of the particles contained in the fluid are not electrically neutral, then an electrophoretic effect depending on charge polarities and on the electric field occur in addition to the above-mentioned interaction and dielectrophoretic effects.

When the electrodes are AC powered, the particles can move in different directions depending on their nature and their size, depending on the frequency of the AC, because of the frequency dependency of the Clausius Mosotti factor, which gives the effective dipole of a particle immersed in a dielectric fluid (see for example FIG. 4 of the article by N. G. Green and H. Morgan in J. Phys. D: Appl. Phys. 31, 1998, L25-L30). If some of the particles contained in the liquid are electrically charged, no electrophoretic effect occurs in addition to the dielectrophoretic effect.

In general, the electrodes 22 and 24 may be opaque or semitransparent. The fluid (liquid) 18 may be transparent or colored depending on the application. The particles 20 may optionally be identical, and they may be of the same color or of different colors, and they may have optical characteristics of transmission, reflection, and diffusion that are selected as a function of the application. They may also be subjected to special treatments in order to make them independent of one another or on the contrary in order to encourage them to agglutinate. Finally, it is possible to add charged particles to the dielectric particles that are in suspension in the fluid.

In the embodiment of FIG. 2, the electrodes of each plate are formed by combs 22, 23 and 24, 25 that are interleaved in one another in pairs, the electrodes of two interleaved combs being capable of taking up electrical voltages of polarities that are identical or opposite. In addition, depending on the desired overall effects (display effects, opaqueness, reflection, diffusion, or transmission), the sets of electrodes 22, 23, 24, and 25 may be identical or different. In particular, the electrodes 22, 23, 24, and 25 may differ from one another in their kinds, their shapes, their dimensions, their spacings, and/or in the polarities of the electrical voltages that are applied thereto.

Three possible modes of operation for active glazing of the invention are shown diagrammatically in FIGS. 3, 4, and 5.

In FIG. 3, the electrodes 22, 23, 24, and 25 of the plates 10, 12 are identical and in transverse alignment from one plate to the other, with the distances between the electrodes formed on a given plate being greater than the width of the electrodes.

When the electrodes are not powered, the particles 20 in suspension in the fluid are disposed in more or less uniform and random manner between the plates on the light path and give an overall optical effect that is determined by the nature of the particles and by their properties (for example the glazing may be generally reflective when the particles 20 have reflective properties, or more or less opaque for particles that are not reflective).

When the electrodes are fed with DC, e.g. with the electrodes 22 and 23 at a negative voltage and the electrodes 24 and 25 at a positive voltage, then the particles 20 are grouped together between the aligned electrodes of opposite polarity and form webs 30 between these electrodes, as shown, the webs 30 being perpendicular to the plates. The particles thus release the major fraction of the volume between the plates, thereby obtaining an overall “transparent” effect (or having the color of the fluid 18 in which the particles are in suspension), the particles being grouped and held together away from the path of light passing through the plates 10, 12.

In FIG. 4, only the electrodes 22 and 23 of the plate 10 are electrically powered and each of the electrodes 22 is of polarity opposite to that of two adjacent electrodes 23. Webs of particles 32 are thus formed between the electrodes 22 and 23, with these webs being parallel to the plate 10, and the resulting overall effect is due to the optical properties of the particles (e.g. of reflecting or opaque appearance), the particles being grouped together and held on the part of the light path.

In a variant, when the electrodes 24 and 24 are powered in the same way as the electrodes 22 and 23, and when the electrodes 24 facing the electrodes 22 have a voltage of the same polarity as said electrodes 22, webs of particles also form between the electrodes 22, 25 over the plate 12.

In FIG. 5, the disposition and the powering of the electrodes 22, 23, 24, and 25 correspond to the description given with reference to FIG. 3, however the electrodes are of width greater than the distance between the electrodes formed on a given plate. When these electrodes are powered as shown, dense sheets of particles 34 form between the facing electrodes on the two plates, giving an overall effect that is more or less opaque, or reflective, or diffusing, for example, as a function of the nature of the particles and the width of the electrodes, where said width may vary from one zone to another in the glazing. Under such circumstances, the electrodes are semitransparent.

A wide variety of overall effects can thus be obtained, in particular display effects, by controlling the supply of electricity to various groups of electrodes 22, 23, 24, and 25, and these effects can be reinforced and refined by having electrodes that differ in terms of shapes, size, location, etc. By using different power supply frequencies for the electrodes, it is possible to separate different particles and store them separately on the sets of electrodes, and then release them selectively so as to obtain a display with particular desired effects (absorption, diffusion, color, metallic reflection, etc. . . . ).

The results obtained in FIGS. 3, 4, and 5 can also be obtained when the electrodes are powered using AC, with variations due to effects that depend on frequency (the sign of the dielectrophoretic force due to the sign of the Clausius Mosotti factor, electromechanical effects on the particles that differ between a DC electric field and an AC electric field, etc.).

1. Optically active glazing having optical characteristics of transmission, diffusion, reflection, and/or color that can be varied under control, the glazing comprising two plates of material that are parallel and that define between them a closed volume, a fluid contained in said volume between the plates, a suspension of dielectric particles in the fluid, and control means for applying electric field gradients to said particles enabling the particles to be moved and organized in directions that are parallel to the plates or perpendicular to the plates under the action of interactions and dielectrophoretic forces.

2. Glazing according to claim 1, wherein the means for applying electric field gradients comprise electrodes placed on said plates in said volume, and means connecting said electrodes to an electrical power supply.

3. Glazing according to claim 2, wherein each plate carries at least two groups of electrodes.

4. Glazing according to claim 2, wherein the electrical power supply is a DC supply or an AC supply at a frequency that is steady or variable.

5. Glazing according to claim 2, wherein at least some of the electrodes are opaque.

6. Glazing according to claim 2, wherein at least some of the electrodes are semitransparent.

7. Glazing according to claim 2, wherein the electrodes are wires, tapes, or combs.

8. Glazing according to claim 2, wherein said electrodes are mutually parallel from one plate to the other.

9. Glazing according to claim 2, wherein the electrodes are mutually identical.

10. Glazing according to claim 2, wherein the electrodes are of at least two different types and differ from one another in their dimensions and/or their locations from one plate to the other and/or by the polarities of the electrical voltages that are applied thereto.

11. Glazing according to claim 1, wherein the particles are all of a single type.

12. Glazing according to claim 1, wherein the particles are of at least two different types.

13. Glazing according to claim 1, wherein the particles have determined optical characteristics of color, reflectivity, and/or diffusion.

14. Glazing according to claim 1, wherein the fluid also contains electrically-charged particles.

15. Glazing according to claim 1, wherein the fluid is a dielectric or a poor conductor of electricity.

16. Glazing according to claim 1, wherein the volume between the plates is partitioned into a plurality of small volumes that are separated from one another in substantially leaktight manner.

17. Glazing according to claim 1, wherein one of said plates is opaque.

18. Glazing according to claim 17, wherein said opaque plate is made of metal.

19. Glazing according to claim 1, wherein said plates are made of glass.
